(19) United States
(12) Patent Application Publication
(10) Pub. No.: US 2021/0367277 A1
(43) Pub. Date: Nov. 25, 2021

(54) BATTERY MANAGEMENT DEVICE, BATTERY INFORMATION PROCESSING SYSTEM, AND BATTERY INFORMATION PROCESSING METHOD

(71) Applicant: SUMITOMO ELECTRIC INDUSTRIES, LTD., Osaka-shi, Osaka (JP)

(72) Inventor: Hiroaki TAKECHI, Osaka-shi (JP)

(73) Assignee: SUMITOMO ELECTRIC INDUSTRIES, LTD., Osaka-shi, Osaka (JP)

(21) Appl. No.: 17/058,290

(22) PCT Filed: Feb. 18, 2019
(86) PCT No.: PCT/JP2019/005906

§ 371 Date: Nov. 24, 2020

(30) Foreign Application Priority Data
Jun. 1, 2018 (JP) 2018-106343

(51) Int. Cl. H01M 10/42; H01M 10/48; H02J 7/00

(52) U.S. Cl. CPC H01M 10/425; H01M 10/482; B60L 58/18; H02J 7/0013; H01M 2010/4271; H02J 7/0047

(57) ABSTRACT

A battery management device that is connected to a secondary battery including a plurality of unit cells and that is configured to process information indicating a characteristic of the secondary battery includes: a calculation unit configured to calculate, for each unit cell, a battery characteristic of the secondary battery; and a recording unit configured to record the battery characteristic of each unit cell calculated by the calculation unit, in association with unit cell identification information for identifying the unit cell, and time information indicating a time at which the battery characteristic has been calculated.

### TECHNICAL FIELD

The present invention relates to a battery management device, a battery information processing system, and a battery information processing method. This application claims priority on Japanese Patent Application No. 2018-106343 filed on Jun. 1, 2018, the entire content of which is incorporated herein by reference.

### BACKGROUND ART

Vehicles such as hybrid electric vehicles (HEVs) and electric vehicles (EVs) are becoming prevalent. HEVs and EVs are equipped with secondary batteries. A secondary battery mounted to a vehicle is a battery pack obtained by combining a plurality of battery modules which are each obtained by combining a plurality of battery cells. The battery cell and the battery module each have battery characteristics individually. One battery pack is produced by combining battery cells and battery modules having similar or equivalent battery characteristics. However, when charging/discharging has been repeated due to use, variation occurs in the battery characteristics. A method for reconfiguring a battery pack by selecting reusable battery modules out of a battery pack for which a certain period has elapsed from the start of use thereof, has been proposed.

PATENT LITERATURE 1 discloses a method in which: all of battery characteristics such as full charge capacity, state of health, and the like are measured for each battery module or each battery cell included in a battery pack; and whether or not the battery module or the battery cell is reusable is determined.

NON PATENT LITERATURE 1 indicates that: battery packs are collected; and performances (full charge capacity, state of health) of all battery modules of the collected battery packs are measured and classified for reuse thereof. The collected battery modules are classified into: those to be reused in drive of an HEV or an EV; those to be reused in an industrial vehicle such as a forklift; and those to be reused in a backup power supply or the like.

As methods for deriving battery characteristics of a secondary battery, a method in which parameters of elements of an equivalent circuit are calculated as disclosed in NON PATENT LITERATURE 2, and methods as disclosed in PATENT LITERATURE 2 to PATENT LITERATURE 5, have been proposed.

### CITATION LIST

### Patent Literature

PATENT LITERATURE 1: Japanese Laid-Open Patent Publication No. 2016-152110

PATENT LITERATURE 2: Japanese Laid-Open Patent Publication No. 2018-013456

PATENT LITERATURE 3: Japanese Laid-Open Patent Publication No. 2017-203659

PATENT LITERATURE 4: Japanese Laid-Open Patent Publication No. 2017-194284

PATENT LITERATURE 5: Japanese Laid-Open Patent Publication No. 2017-194283

### Non Patent Literature

NON PATENT LITERATURE 1: “4R Energy ‘LEAF’ no juudenchi wo saiseihinkasuru Namie Jigyousho no jigyou nituite setsumei (provisional translation: 4R Energy describes business of Namie manufacturing plant for remanufacturing secondary batteries of “LEAF”) [online], Impress Corporation, Car Watch [searched on Apr. 11, 2018], the Internet (URL: https://car.watch.impress.co.jp/docs/news/1113869.html)

NON PATENT LITERATURE 2: see “Battery Management System Engineering”, Shuichi Adachi et al., Tokyo Denki University Press, Chapter 6.2.2

### SUMMARY OF INVENTION

A battery management device according to the present disclosure includes: a calculation unit configured to calculate, for each of a plurality of unit cells included in a secondary battery, a battery characteristic in the secondary battery; and a recording unit configured to record the battery characteristic of each unit cell calculated by the calculation unit, in association with unit cell identification information for identifying the unit cell, and time information indicating a time at which the battery characteristic has been calculated.

### BRIEF DESCRIPTION OF DRAWINGS

FIG. 1 shows an outline of a secondary battery reuse system.

FIG. 2 is a block diagram showing configurations of devices mounted to a vehicle V.

FIG. 3 is a perspective view showing a configuration example of a battery module device in Embodiment 1.

FIG. 4 is a block diagram showing a configuration example of a battery management device.

FIG. 5 is a function block diagram of a module control unit in Embodiment 1.

FIG. 6A illustrates an equivalent circuit model of a unit cell (battery module or battery cell).

FIG. 6B illustrates an equivalent circuit model of the unit cell (battery module or battery cell).

FIG. 6C illustrates an equivalent circuit model of the unit cell (battery module or battery cell).

FIG. 7 shows an example of contents of information recorded by a recording unit.

FIG. 8 is a block diagram showing a part of a configuration of an on-vehicle communication system in Embodiment 2.

FIG. 9 is a function block diagram of a control unit of a battery monitoring device in Embodiment 2.

FIG. 10 is a flowchart showing an example of a procedure of a process performed in an on-vehicle communication system.

FIG. 11 shows an outline of a secondary battery reuse system in Embodiment 3.

FIG. 12 is a block diagram showing a part of a configuration of an on-vehicle communication system in Embodiment 3.

FIG. 13 is a block diagram of a server device.

FIG. 14 is a flowchart showing an example of a procedure of a process performed by each device in the secondary battery reuse system of Embodiment 3.

FIG. 15 shows an outline of a secondary battery reuse system in Embodiment 4.

FIG. 16 is a block diagram showing a part of a configuration of an on-vehicle communication system in Embodiment 4.

FIG. 17 shows an outline of distribution of information in a distributed-type DB network system.

### DESCRIPTION OF EMBODIMENTS

### [Problems to be Solved by the Present Disclosure]

In reuse of secondary batteries disclosed in PATENT LITERATURE 1 and NON PATENT LITERATURE 1, measurement is performed at the time of disassembly of a battery pack, to perform evaluation. NON PATENT LITERATURE 1 asserts that 48 battery modules can be measured in a total of four hours. However, if four hours are necessary to measure battery modules of a single small EV, it can be said that a long time is still required. It is difficult to combine battery modules or battery cells that have truly uniform battery characteristics, on the basis of measurement and evaluation of battery characteristics that are obtained through temporary measurement at the time point of disassembly.

As described above, conventional art has the problem of the measurement time of battery characteristics, and the problem of difficulty in combining battery modules or battery cells that have uniform battery characteristics. This results in very slow progress of “reuse of secondary batteries”, i.e., “efficient use of resources”.

An object of the present application is to provide a battery management device, a battery information processing system, and a battery information processing method that can contribute to efficient use of resources such as rare earth elements contained in a secondary battery.

### [Description of Embodiment of the Present Disclosure]

First, embodiments of the present disclosure are listed and described. At least some parts of the embodiments described below may be combined as desired.

(1) A battery management device according to the present mode includes: a calculation unit configured to calculate, for each of a plurality of unit cells included in a secondary battery, a battery characteristic in the secondary battery; and a recording unit configured to record the battery characteristic of each unit cell calculated by the calculation unit, in association with unit cell identification information for identifying the unit cell, and time information indicating a time at which the battery characteristic has been calculated.

In the present mode, the battery characteristic calculated on the basis of a voltage, a current, or a temperature at a unit cell (for each battery cell or each battery module in which a plurality of battery cells are connected) included in a secondary battery is recorded in a device in association with information for identifying the unit cell and time information indicating a time at which the battery characteristic has been calculated. Since the recorded battery characteristic can be read out in an ex post facto manner, a detailed battery characteristic can be obtained without requiring measurement at the reuse or reproduction.

The state of each unit cell can be identified not on the basis of a temporary battery characteristic obtained at the time point of disassembly of a secondary battery for reuse, but on the basis of a history over a long time period of the battery characteristic measured and calculated, at the timing of charge/discharge of the secondary battery, by the device that manages the charge/discharge for each unit cell.

When, for each unit cell, the history of the battery characteristic is recorded in association with unit cell identification information, and the histories of a large number of unit cells are collected, it is possible to quickly specify which unit cells should be combined to be reused. Traceability of unit cells can be improved, and reuse for each unit cell can be promoted. When unit cells that have uniform characteristics according to battery characteristics obtained in actual use thereof are reused as a battery pack, rapid deterioration of each unit cell can also be prevented, and thus, resources can be efficiently used.

(2) The control unit detects arrival of a replacement time of the secondary battery on the basis of the battery characteristic recorded in the recording unit.

In the present mode, the replacement time of the secondary battery can be accurately detected on the basis of the history of the battery characteristic. When the secondary battery is combined to be reused for another usage before deterioration advances, efficient use of each unit cell of the secondary battery is realized. Provision in the device connected to the secondary battery allows realization of a simple configuration.

(3) A battery information processing system according to the present mode is configured to process information indicating a characteristic of a secondary battery including a plurality of unit cells. The battery information processing system includes: a plurality of battery management devices connected to the plurality of unit cells and each configured to calculate a battery characteristic for each unit cell; and a recording device configured to record, separately for each unit cell, the battery characteristic calculated for each unit cell, in association with unit cell identification information for identifying the unit cell and time information indicating a time at which the battery characteristic has been calculated.

In the present mode, the recording device may not necessarily be provided in the battery management device, and may be provided in a separate device in an apparatus (vehicle) that operates by receiving supply of power from the secondary battery, or may be provided at another device outside the apparatus. When the recording device is provided in a separate device, it is easy to comprehensively identify battery characteristics of a plurality of unit cells and to make determination in consideration of the state of the apparatus (vehicle).

(4) The recording device is provided to a device different from an apparatus that operates by receiving supply of power from the secondary battery. The battery management device includes a transmission unit configured to transmit the calculated battery characteristic to the recording device, in association with the unit cell identification information and the time information. The recording device includes a reception unit configured to receive the battery characteristic, and records the received battery characteristic of each unit cell in association with the unit cell identification information and the time information.

In the present mode, the recording device is provided outside the apparatus, and the battery management device transmits, to the recording device, the calculated battery characteristic in association with the time information. A huge amount of battery characteristics of secondary batteries are recorded in the recording device. Since analysis of the battery characteristics is executed by the device that is present outside the apparatus and that can have abundant hardware resources, the replacement time can be detected with high accuracy, and reuse of secondary batteries can be expected to be urged and efficiently performed by, for example, issuing a notification to a related agency, without causing processes to be completed in the apparatus.

(5) The battery characteristic includes at least one of a full charge capacity, a state of charge, a state of health, and a battery equivalent circuit parameter of the unit cell.

In the present mode, information that can accurately identify the state, even through ex post facto reference, by use of any one of the full charge capacity, state of charge, state of health, and battery equivalent circuit parameter of the unit cell, is recorded.

(6) The battery information processing system further includes a reading device configured to read out the battery characteristic recorded in the recording device. The reading device includes a detection unit configured to detect arrival of a replacement time on the basis of the read out battery characteristic.

In the present mode, the replacement time of the secondary battery can be accurately detected on the basis of the history of the battery characteristics, by a reading device that reads out the history of the recorded battery characteristic of each unit cell. When the unit cell is incorporated into a new secondary battery or reused for another usage before deterioration advances, efficient use of each unit cell of the secondary battery is realized. Since the detection of the replacement time is not performed in the battery management device but is performed by the reading device, it is also possible to realize comprehensive detection using another type of information such as information of the apparatus itself to which the secondary battery is provided.

(7) The recording device is a distributed-type database network system, the distributed-type database network system being formed by a plurality of recording mediums and processing nodes each configured to perform arithmetic operation of verifying and approving record information for recording attribution of information on the basis of an electronic signature obtained from secret key information corresponding to a transfer source, the distributed-type database network system being configured to record information such that results of the arithmetic operations are distributed in a plurality of recording mediums. The battery information processing system includes a node, the node being connected to the battery management device and configured to transmit, to the distributed-type database network system, a transaction of recording the battery characteristic calculated by the battery management device into the distributed-type database network system.

In the present mode, recording of the battery characteristic is performed in a distributed-type database network system that is a so-called block chain. By performing the recording in a state where the battery characteristics are made public and falsification is difficult to be performed, it is possible to improve traceability of each unit cell and to increase the value, as resources, of the unit cell of which the history information is assured.

(8) The node creates the transaction on the basis of a signature using address information obtained on the basis of secret key information and different for each unit cell.

In the present mode, recording of the battery characteristic is realized by a transaction that uses a signature using address information based on secret key information and different for each unit cell and that is performed from the node connected to the battery management device, to a specific node in the distributed-type database network system. Since the address information is provided to each unit cell, the address information also corresponds to unit cell identification information.

(9) The distributed-type database network system includes a node configured to process a transaction of registering a transfer by using unit cell identification information, for each unit cell.

In the present mode, since the distributed-type database network system is used, recording of a transfer performed when the secondary battery is new and a transfer performed when unit cells are recombined for reuse, can also be realized. Since the transfer of an asset of a unit cell is recorded in the distributed-type database network system, rating of the value as an asset on the basis of the history can be realized.

(10) A battery information processing method for processing information indicating a characteristic of a secondary battery including a plurality of unit cells includes: calculating, performed by a device connected to the plurality of unit cells, a battery characteristic for each unit cell; recording, separately for each unit cell, the battery characteristic calculated for each unit cell, in association with time information indicating a time at which the battery characteristic has been calculated; and identifying a state of each unit cell, on the basis of a history of the battery characteristic recorded separately for each unit cell.

In the present mode, similar to mode (1), a battery characteristic calculated on the basis of a voltage, a current, or a temperature at a unit cell (for each battery cell or each battery module in which a plurality of battery cells are connected) included in a secondary battery is recorded in a device or outside the device, in association with information for identifying the unit cell and time information indicating a time at which the battery characteristic has been calculated. Since the recorded battery characteristic can be read out in an ex post facto manner, the state of each unit cell can be identified without newly performing measurement.

The present application can be realized not only as a battery management device having such characteristic components, but also as a battery information management method including characteristic steps executed by the battery management device, and as a program for causing a computer to execute these steps. The present application can be realized not only as a single body of the battery management device, but as a battery module device also including unit cells, as a vehicle communication system including a communication device that transmits/receives information through communication to/from the battery module device, and further as a vehicle provided with the vehicle communication system. The present application can be realized as a semiconductor integrated circuit that realizes a part or all of components of the battery management device, as a battery reuse system using information to be processed by the battery management device, and as another system further including these.

[Effects of the Present Disclosure]

According to the present disclosure, a battery management device, a battery information processing system, and a battery information processing method that can contribute to efficient use of resources such as rare earth elements contained in secondary batteries can be provided.

[Details of Embodiment of the Present Disclosure]

Hereinafter, specific examples of a battery management device and a battery information processing system according to an embodiment of the present invention will be described with reference to the drawings. The present invention is not limited to these examples, and is defined by the scope of the claims and is intended to include meaning equivalent to the scope of the claims and all modifications within the scope.

(Embodiment 1)

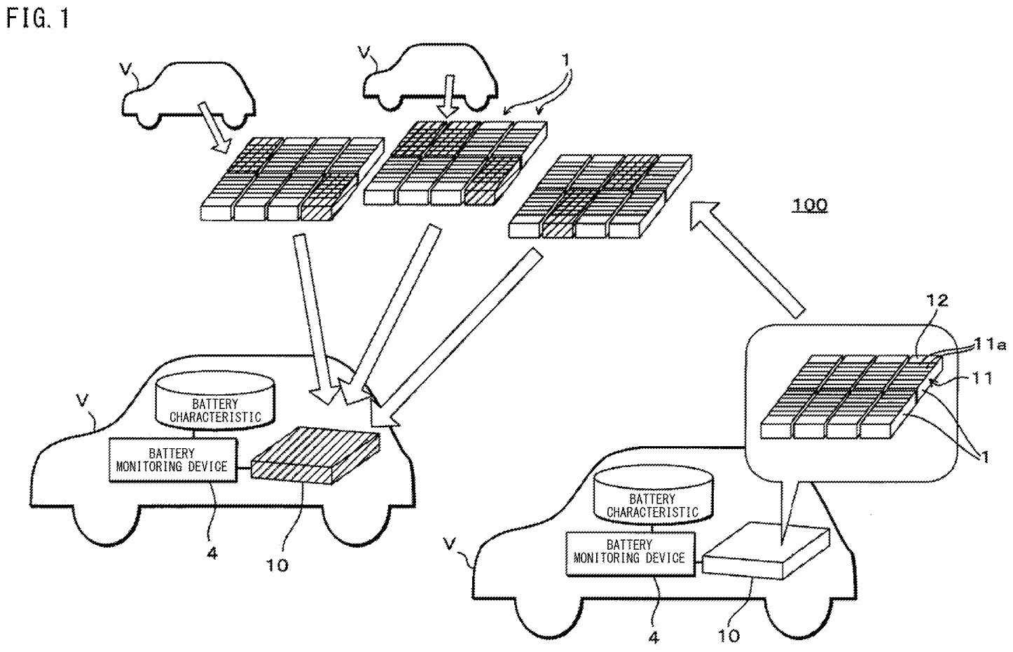

FIG. 1 shows an outline of a secondary battery reuse system 100. The secondary battery reuse system 100 is a system that supports reuse of a secondary battery 10 used in a vehicle V that is an EV or an HEV. The secondary battery reuse system 100 enables selecting, out of used secondary batteries 10, battery modules 11 that have similar battery characteristics, and reproducing a secondary battery 10 by combining the selected battery modules 11. A battery module of which the output voltage during discharge, among battery characteristics, is still high and of which the deterioration has not been advanced is reused in a secondary battery 10 for a vehicle V. Depending on battery characteristics, in particular, depending on the degree of state of health, a battery module 11 can be used, other than in the vehicle V, for example, in a small vehicle such as a forklift or a golf cart, or in a storage battery that is used in a backup power supply.

The secondary battery 10 includes a lithium ion battery, for example. The secondary battery 10 includes a plurality of battery modules (unit cells) 11 each composed of a plurality of battery cells (unit cells) 11a that are connected in series or in series-parallel and that are housed in a housing.

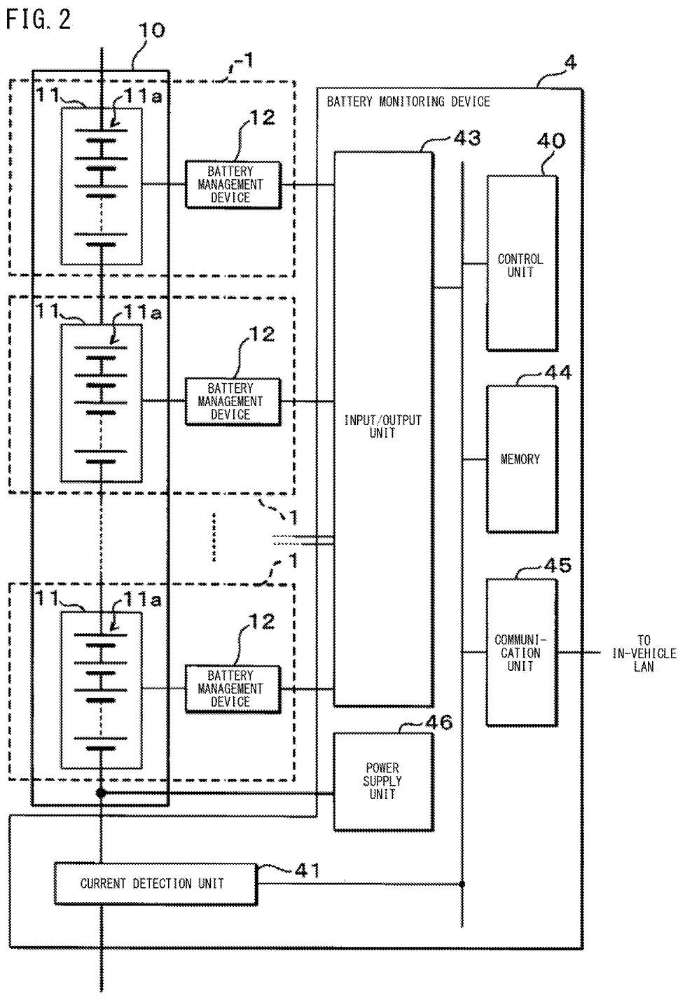

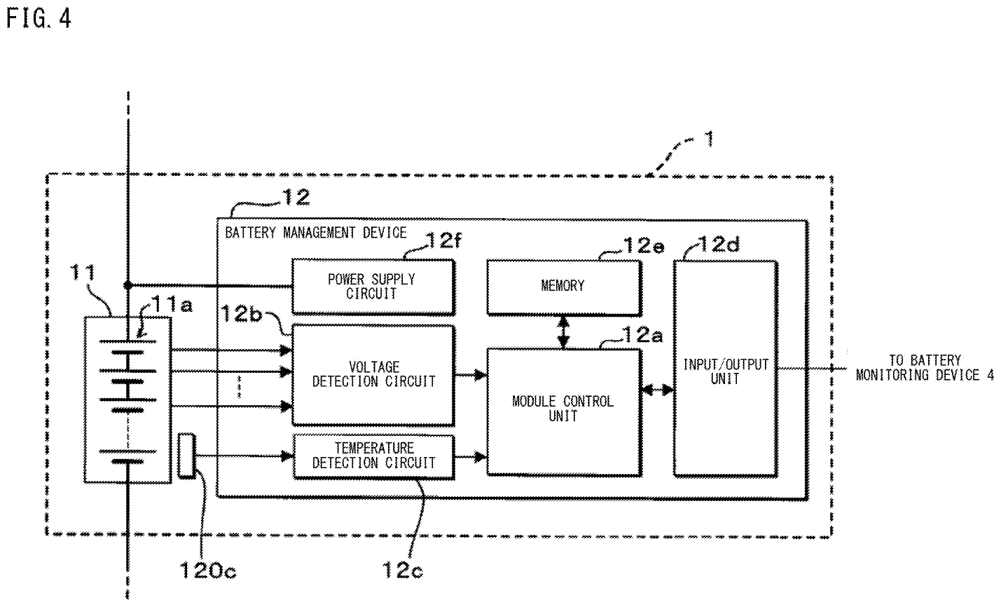

The secondary battery reuse system 100 of Embodiment 1 includes a battery information processing system that includes: a plurality of battery management devices (see FIG. 2) which each calculate battery characteristics for each of a plurality of unit cells; and a recording device (a module control unit 12a and a memory 12e in FIG. 4) which records the calculated battery characteristics. In the secondary battery reuse system 100, battery characteristics of the battery modules 11 of the secondary battery 10 mounted to the vehicle V are sequentially calculated by the battery information processing system and recorded. As a method for calculating battery characteristics, it is preferable to use a highly accurate method that is not dependent on uniformity of the environment such as maintaining a constant temperature. After reuse has been determined, if a situation where measurement has to be performed for the first time at the time of disassembly is avoided and sufficient information has been recorded, measurement at the time of disassembly can be made unnecessary. The method for calculating battery characteristics will be described later.

The battery characteristics calculated for each unit cell are associated with information identifying the unit cell, and are recorded such that the battery characteristics can be referred to in an ex post facto manner. Accordingly, it is possible to determine whether or not the secondary battery 10 can be reused, and it is possible to eliminate the need of measurement for determining which unit cells are to be combined. By referring to the record, it is possible to determine: whether the secondary battery 10 is in a state where the secondary battery 10 should be provided for production of a reuse article; and which unit cells should be combined.

Calculation of battery characteristics to be used in the secondary battery reuse system 100 is described. FIG. 2 is a block diagram showing configurations of devices mounted to the vehicle V. With respect to the secondary battery 10, at least a battery module device 1 and a battery monitoring device 4 are mounted to the vehicle V. A power supply system using the secondary battery 10 in the vehicle V includes a relay, a generator (ALT), a starter motor, a battery, an electric load, a starting switch, a charger, and the like, in addition to the battery module device 1. Detailed description of the power supply system is omitted.

The battery module device 1 uses one battery management device (BMU: Battery Management Unit) 12 associated with a battery module 11 that forms a part of the secondary battery 10. The battery management device 12 has an input/output unit 12d (see FIG. 4), and can transmit/receive information to/from the battery monitoring device 4.

The battery monitoring device 4 includes a control unit 40, a current detection unit 41, an input/output unit 43, a memory 44, a communication unit 45, and a power supply unit 46.

The control unit 40 is implemented as a microcomputer having a processor such as a CPU (Central Processing Unit), a ROM (Read Only Memory), a RAM (Random Access Memory), a time measuring unit, an input/output interface, etc., a dedicated LSI (Large-Scale Integration), an FPGA (Field-Programmable Gate Array), or the like. The control unit 40 transmits/receives information via the input/output unit 43 to/from the battery management device 12 which calculates information indicating battery characteristics of each unit cell (battery module 11 or battery cell 11a), and processes the information.

The current detection unit 41 is implemented as a shunt resistor, a Hall sensor, or the like for detecting the current of the secondary battery 10, for example, and detects a charge current or a discharge current of the secondary battery 10 in a predetermined sampling cycle. The sampling cycle is 10 milliseconds, for example, but is not limited thereto. The control unit 40 sequentially outputs a current value detected by the current detection unit 41 to each battery management device 12 through the input/output unit 43. As shown in FIG. 2, the secondary battery 10 is formed by connecting the battery modules 11 in series each obtained by connecting the battery cells 11a in series. Thus, when the current at one end of the secondary battery 10 is detected by one current detection unit 41, the current flowing in each unit cell (battery module 11 or battery cell 11a) can be detected. It is understood that the current detection unit 41 may be configured as a current detection circuit included in each battery management device 12 described later, to detect a current.

The input/output unit 43 is an input/output interface between the control unit 40 and a plurality of battery management devices 12, and is connected to a communication bus corresponding to each battery management device 12. The input/output unit 43 may be replaced by a wireless communication module, and the wireless communication module may wirelessly transmit/receive information to/from each battery management device 12.

The memory 44 includes a nonvolatile memory such as a flash memory. The memory 44 has stored therein management device identification information (BMU-ID) of each of the plurality of battery management devices 12 connected to the device. The management device identification information may be stored in advance as settings. Alternatively, the control unit 40 may input/output a signal with respect to each battery management device 12, and collect the management device identification information. The memory 44 may have stored therein, for each unit cell (battery module 11 or battery cell 11a) of the secondary battery 10, unit cell identification information (MID: module ID/CID: cell ID) that identifies the unit cell.

The communication unit 45 is a communication module that realizes communication corresponding to an in-vehicle LAN (Local Area Network). The communication unit 45 can transmit/receive information to/from another on-vehicle device through CAN (Controller Area Network), for example. The communication unit 45 may be a wireless communication module that has a wireless communication antenna.

The power supply unit 46 is a circuit that converts power from the secondary battery 10 so as to have a predetermined voltage value and that supplies the resultant power to each component.

In the battery monitoring device 4 having the above configuration, the control unit 40 comprehensively identifies the state of the secondary battery 10 on the basis of information obtained from the battery management device 12 of each battery module device 1, thereby detecting an abnormality, and executes transmission/reception of information to/from another device.

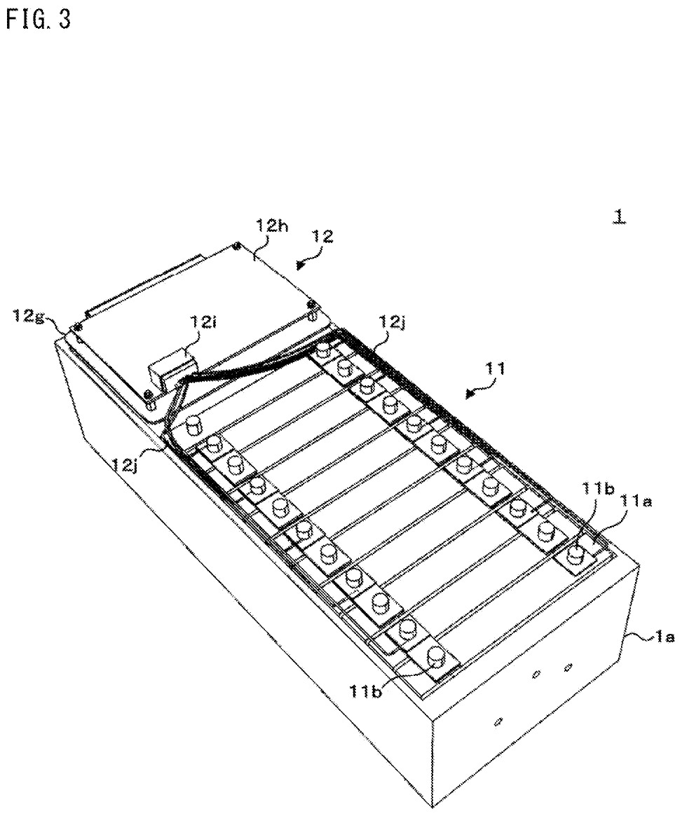

FIG. 3 is a perspective view showing a configuration example of the battery module device 1 in Embodiment 1. The battery module device 1 has a quadrangular prism shape as a whole. The battery module 11 is formed by stacking, in the thickness direction, a plurality of battery cells 11a each having a plate shape. Each battery cell 11a has a pair of electrode terminals 11b at both end portions thereof, and the plurality of electrode terminals 11b at each end are linearly arrayed in the stacking direction.

The battery module 11 is held by a holding member 1a. In the holding member 1a, a substantially rectangular parallelepiped portion is formed in an extended manner on one end side in the stacking direction of the battery cells 11a, and a support plate 12g for supporting the battery management device 12 is provided on one face side of the rectangular parallelepiped portion.

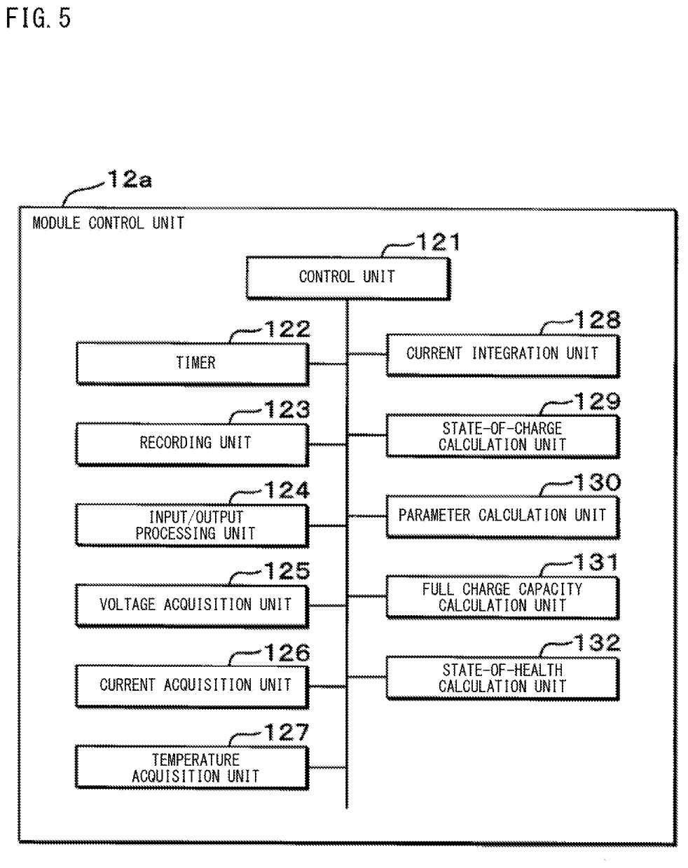

The battery management device 12 includes a circuit board 12h having mounted thereon circuits (see FIG. 5) that execute processes. The circuit board 12h is supported by the support plate 12g so as to be substantially parallel to one-side face where the electrode terminals 11b of the battery cells 11a are arrayed. A connection terminal 12i is provided, on the battery cell 11a side, at an appropriate position of the circuit board 12h. The electrode terminals 11b of the plurality of battery cells 11a are connected by conductive wires 12j to the connection terminal 12i. Each conductive wire 12j is provided along the array of the electrode terminals 11b arranged in the stacking direction. One end of the conductive wire 12j is connected to one electrode terminal 11b of the battery cell 11a, and the other end is connected to the connection terminal 12i.

FIG. 4 is a block diagram showing a configuration example of the battery management device 12. As shown in FIG. 2, a plurality of battery management devices 12 are provided so as correspond to the respective battery modules 11. Since each battery management device 12 has the same configuration, one battery management device 12 will be described.

The battery management device 12 includes: the module control unit 12a which controls overall operation of the device; a voltage detection circuit 12b; a temperature detection circuit 12c; the input/output unit 12d; the memory 12e; and a power supply circuit 12f, which are mounted on the circuit board 12h.

The voltage detection circuit 12b detects the voltage between both ends of the battery module 11 in a predetermined sampling cycle, and outputs information indicating the detected voltage, to the module control unit 12a. The voltage detection circuit 12b may detect the voltage of each of the plurality of battery cells 11a included in the battery module 11. The sampling cycle is 10 milliseconds, for example, but is not limited thereto.

The temperature detection circuit 12c notifies the module control unit 12a of a surface temperature of one or a plurality of places among the plurality of battery cells 11a in the battery module 11. By using a temperature sensor 120c implemented as, for example, a thermistor, the temperature detection circuit 12c reads a temperature on the basis of the signal level of an output signal from the temperature sensor 120c. One temperature sensor 120c may be provided to the battery module 11, or may be provided for each battery cell 11a. The use of the thermistor is an example. A known temperature sensor may be used as the temperature sensor 120c. For example, the temperature may be detected by using a temperature-measuring resistor, a semiconductor temperature sensor, a thermocouple, or the like.

The temperature detection may be realized by using a temperature sensor provided at one or a plurality among the plurality of battery modules 11. In this case, the battery monitoring device 4 reads a temperature from an output signal of the temperature sensor, and notifies each battery management device 12 via the input/output unit 12d.

The input/output unit 12d is an input/output terminal with respect to the battery monitoring device 4. The battery management device 12 transmits/receives a signal (information) to/from the battery monitoring device 4 via the input/output unit 12d.

The memory 12e is a nonvolatile memory such as a flash memory. In a non-rewritable region (Read Only) of the memory 12e, the management device identification information (BMU-ID) of the device is stored. The memory 12e stores information generated through processing performed by the module control unit 12a.

The power supply circuit 12f is a circuit that converts power supplied from the battery module 11 so as to have a voltage appropriate for drive of each component of the battery management device 12, and that feeds the resultant power to each component of the battery management device 12.

The module control unit 12a is implemented as a microcomputer having a processor such as a CPU, a ROM, a RAM, a time measuring unit, an input/output interface, etc., a dedicated LSI, an FPGA, or the like. The voltage detection circuit 12b, the temperature detection circuit 12c, the input/output unit 12d, and the memory 12e are connected to the input/output interface of the module control unit 12a.

FIG. 5 is a function block diagram of the module control unit 12a in Embodiment 1. The module control unit 12a functions as a control unit 121 which controls the entirety of the device, a timer 122, a recording unit 123, an input/output processing unit 124, a voltage acquisition unit 125, a current acquisition unit 126, a temperature acquisition unit 127, a current integration unit 128, a state-of-charge calculation unit 129, a parameter calculation unit 130, a full charge capacity calculation unit 131, and a state-of-health calculation unit 132.

The module control unit 12a controls, as the control unit 121, each unit and calculates battery characteristics of each unit cell, which is a battery module 11 or a battery cell 11a, on the basis of the voltage, temperature, and current that are detected. As the battery characteristics, the module control unit 12a calculates a full charge capacity (FCC), a state of charge (SOC), a state of health (SOH), and an equivalent circuit parameter, for example.

The module control unit 12a functions as the timer 122 by using a built-in time measuring unit. The timer 122 outputs a time measurement result to the control unit 121. For storing the calculated battery characteristics in time series, the control unit 121 associates time information therewith on the basis of the output from the timer 122.

The module control unit 12a functions as the recording unit 123 by using the memory 12e. The recording unit 123 records various types of information indicating battery characteristics calculated for each unit cell. The memory 12e has stored therein information for calculating the battery characteristics. For example, information which is referred to in order to calculate a state of charge (SOC) for each unit cell is recorded. For example, the memory 12e has stored therein in advance correlation between open circuit voltage (OCV) and state of charge of the unit cell (for each battery cell 11a or battery module 11).

The memory 12e has stored therein unit cell identification information (MID) of the battery module 11, which is a management target. The memory 12e may have stored therein unit cell identification information (CID) of each of the plurality of battery cells 11a forming the battery module 11. Preferably, the unit cell identification information (MID/CID) is stored through processing of the recording unit 123 via a specific device or the battery monitoring device 4 by a work operator, when the secondary battery 10 including the battery module 11 is mounted. A storage medium storing the unit cell identification information (MID/CID) may be mounted to each of the battery module 11 or the battery cells 11a, and the unit cell identification information may be read out from the storage medium by the control unit 121, to be stored.

The memory 12e has stored therein the initial (when the unit cell is new) full charge capacity or an equivalent circuit parameter of each unit cell, as information for calculating the state of health of each unit cell. The full charge capacity or equivalent circuit parameter is preferably stored in, for example, the connection order of the unit cells so as to be able to be separately read out. The memory 12e may have stored therein, as information for calculating the state of health of each unit cell, relationship between increase rate of internal resistance and discharge capacity ratio corresponding to the state of health. These pieces of information when the unit cell is new may be stored through work by the above-described work operator.

The module control unit 12a controls, as the input/output processing unit 124, transmission/reception of information to/from the battery monitoring device 4 via the input/output unit 12d. The input/output processing unit 124 can transmit/receive information (FCC, SOC, SOH, or an equivalent circuit parameter) indicating a battery characteristic of each unit cell to/from the battery monitoring device 4.

The module control unit 12a functions as the voltage acquisition unit 125, the current acquisition unit 126, and the temperature acquisition unit 127 which respectively acquire a voltage, a current, and a temperature to be used in calculation of the battery characteristics.

The voltage acquisition unit 125 acquires information indicating the voltage between both ends of the battery module 11 or the voltage of each battery cell 11a outputted from the voltage detection circuit 12b. The voltage acquisition unit 125 may acquire the voltage between both ends of the battery module 11 and the voltage at each battery cell 11a in a mutually-distinct manner.

The current acquisition unit 126 acquires, as a current value of the unit cell, information indicating the current flowing in the battery module 11 or battery cell 11a obtained from the battery monitoring device 4 via the input/output unit 12d.

The temperature acquisition unit 127 acquires information indicating the temperature outputted from the temperature detection circuit 12c.

The module control unit 12a integrates, as the current integration unit 128, the current value acquired by the current acquisition unit 126. The integrated value of the current is obtained by integrating the current over time, and corresponds to the amount of change in the charge amount. The integrated value of the current is positive in the case of charge, and is negative in the case of discharge. An integrated value in a certain period can be positive or negative in accordance with the magnitude of the values of the charge current and the discharge current in the period. The timing to start integration calculation is the activation timing of the secondary battery 10, or the battery module device 1 or the battery monitoring device 4. The integrated value is continuously calculated. The integrated value may be reset at a predetermined timing, for example, in the case of reuse, at a timing when battery modules 11 are recombined.

The module control unit 12a calculates, as the state-of-charge calculation unit 129, a state of charge of each unit cell, which is the battery module 11 or battery cell 11a. The state-of-charge calculation unit 129 calculates an open circuit voltage in the unit cell, which is the battery module 11 or battery cell 11a. The state-of-charge calculation unit 129 calculates, as estimation, a state of charge, by checking the calculated open circuit voltage against the correlation between open circuit voltage and state of charge stored in the recording unit 123. Using a state of charge at a specific time point as a reference, the state-of-charge calculation unit 129 may calculate a state of charge by using the charge current and the discharge current obtained through integration by the current integration unit 128, and a full charge capacity described later.

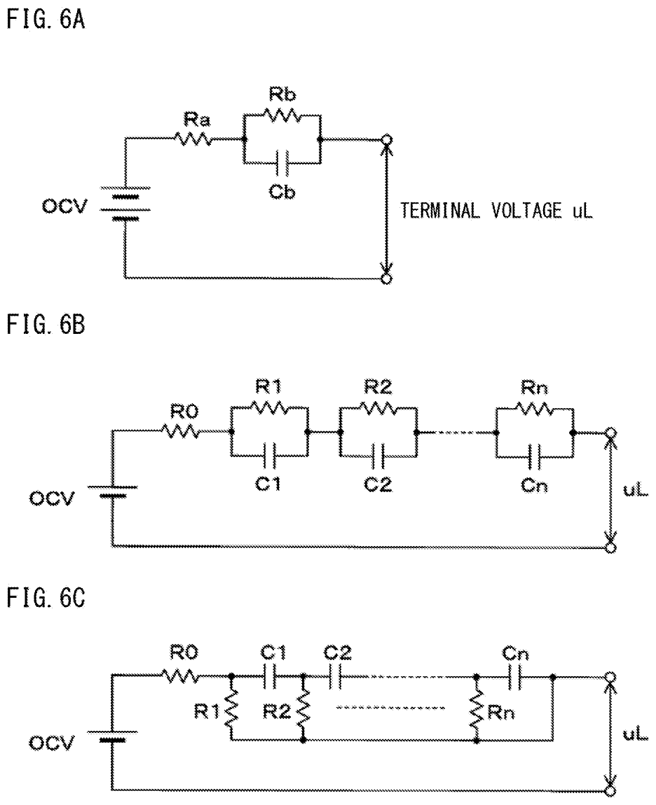

The module control unit 12a calculates, as the parameter calculation unit 130, a parameter of each element of an equivalent circuit corresponding to the unit cell. The parameters are resistance values Ra, Rb, a capacitance Cb of a capacitor, and the like in the equivalent circuit. FIG. 6A, FIG. 6B, and FIG. 6C each illustrate an equivalent circuit model of the unit cell (battery module 11 or battery cell 11a). In the equivalent circuit model shown in FIG. 6A, the equivalent circuit is represented by a circuit in which a resistor Ra, and a parallel circuit of a resistor Rb and a capacitor Cb are connected in series to a voltage source having the open circuit voltage as an electromotive force. The resistor Ra corresponds to electrolyte resistance. The resistor Rb corresponds to charge transfer resistance. The capacitor Cb corresponds to electric double layer capacitance. The resistor Ra may include charge transfer resistance, and the resistor Rb may correspond to diffusion resistance.

The equivalent circuit of the unit cell is not limited to that shown in FIG. 6A. For example, as shown in FIG. 6B, the equivalent circuit may be an n-th order (n is a natural number) Foster type RC ladder circuit represented by approximation with the sum of infinite series, in which n parallel circuits of a resistor Rj and a capacitor Cj (j=1, 2, . . . , n) are connected in series to a resistor R0. Alternatively, as shown in FIG. 6C, the equivalent circuit may be an n-th order Cowell type RC ladder circuit in which ends of n resistors Rj (j=1, 2, . . . , n) are connected to each other and the other ends of the n resistors Rj are connected between n capacitors Cj connected in series.

The internal parameters of the equivalent circuit models shown in FIG. 6A, FIG. 6B, and FIG. 6C can be obtained by estimating, by a least squares method, parameters in approximate equations using a voltage value and a current value, for example. As the parameter estimation method, a known method may be used (for example, see “Battery Management System Engineering”, Shuichi Adachi et al., Tokyo Denki University Press, Chapter 6.2.2).

The internal parameters Ra, Rb, Cb may be calculated by using a Kalman filter. Specifically, the parameter calculation unit 130 compares an observation vector obtained when an input signal represented by a terminal voltage and a current is given to the unit cell and a state vector obtained when the same input signal is given to the equivalent circuit model of the unit cell. As a result of the comparison, the parameter calculation unit 130 multiplies the error between these vectors by the Kalman gain, and feeds back the result to the equivalent circuit model, thereby repeating correction of the equivalent circuit model such that the error between these vectors is minimized. The parameter calculation unit 130 can also estimate the internal parameters in this manner.

With reference back to FIG. 5, description of the functions of the module control unit 12a is continued. The module control unit 12a calculates, as the full charge capacity calculation unit 131, a full charge capacity per cell for each battery cell 11a. Various methods can be adopted as a full charge capacity calculation method performed by the full charge capacity calculation unit 131. For example, the full charge capacity calculation unit 131 checks a first open circuit voltage of the battery cell 11a at a first time point at which the starting switch is in an OFF state in a first trip period from the turn-on time point of the starting switch of the vehicle V to the next turn-on time point thereof, against the stored correlation, and calculates a first state of charge by means of the state-of-charge calculation unit 129. The full charge capacity calculation unit 131 calculates a second state of charge by means of the state-of-charge calculation unit 129 on the basis of a second open circuit voltage in a second time point at which the starting switch is in an OFF state in a second trip period. The full charge capacity calculation unit 131 calculates, by means of the current integration unit 128, a charge/discharge amount on the basis of a charge/discharge current acquired by the current acquisition unit 126 in a period from the first time point to the second time point. The full charge capacity calculation unit 131 calculates a full charge capacity per cell for each battery cell 11a, on the basis of the first state of charge, the second state of charge, and the charge/discharge amount that have been calculated. The full charge capacity calculation unit 131 can also calculate a full charge capacity for each battery module 11 on the basis of the full charge capacity of each battery cell 11a. As the full charge capacity calculation method, another known method or a new method may be used.

The module control unit 12a calculates, as the state-of-health (SOH) calculation unit 132, a state of health of each unit cell, which is the battery module 11 or battery cell 11a. For example, the state-of-health calculation unit 132 calculates a state of health, by comparing the full charge capacity of the unit cell calculated by the full charge capacity calculation unit 131 against the initial full charge capacity stored in the recording unit 123. The state-of-health calculation unit 132 may calculate a proportion (degree of increase) of an internal resistance value R calculated by the parameter calculation unit 130 with respect to the secondary battery 10, against an initial value R0, and may calculate a state of health on the basis of the correlation between internal resistance increase rate and discharge capacity ratio stored in the recording unit 123. Further, the state-of-health calculation unit 132 may calculate a state of health by comparing the initial value of the equivalent circuit parameter stored in the recording unit 123 with a value calculated by the parameter calculation unit 130.

For the state-of-charge calculation unit 129, the parameter calculation unit 130, the full charge capacity calculation unit 131, and the state-of-health calculation unit 132 described above, various methods can be used for calculation of the battery characteristic. For the state-of-charge calculation unit 129, the parameter calculation unit 130, the full charge capacity calculation unit 131, and the state-of-health calculation unit 132, methods disclosed in Japanese Laid-Open Patent Publication No. 2018-013456, Japanese Laid-Open Patent Publication No. 2017-203659, Japanese Laid-Open Patent Publication No. 2017-194284, Japanese Laid-Open Patent Publication No. 2017-194283, and the like may be used, for example.

The module control unit 12a calculates, as the control unit 121, all or a part of the battery characteristics such as the state of charge, the equivalent circuit parameter, the full charge capacity, and the state of health in a predetermined cycle such as 10 milliseconds, temporarily stores the calculated battery characteristics, and performs charge/discharge control in accordance with the battery characteristics. The control unit 121 outputs the battery characteristics to the battery monitoring device 4. The battery monitoring device 4 calculates the battery characteristics of the entirety of the secondary battery 10, and provides information for charge/discharge control as a whole, or for travel control, etc., to another on-vehicle device.

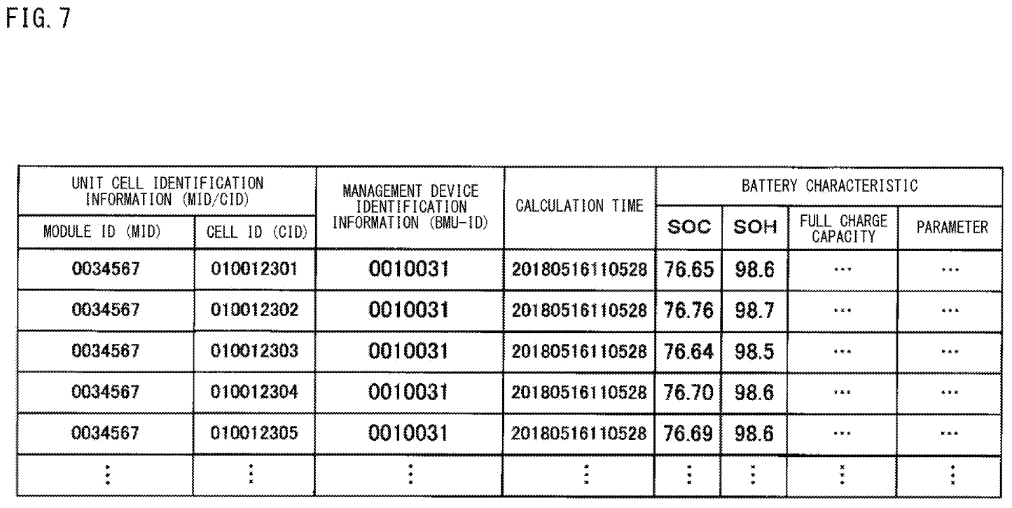

In the battery management device 12 in Embodiment 1, the recording unit 123 records, into the memory 12e at a predetermined recording timing, these pieces of information indicating the sequentially calculated battery characteristics, in association with time information. FIG. 7 shows an example of contents of information recorded by the recording unit 123. The recording unit 123 associates the information indicating a battery characteristic (FCC, SOC, SOH, or an equivalent circuit parameter) with the unit cell identification information (MID/CID) and the management device identification information (BMU-ID), and records the resultant information together with time information (calculation time) that can be acquired by the timer 122.

The recording timing is, for example, a timing at which the starting switch enters an ON state from an OFF state, for each constant period such as once in a month. The recording unit 123 continuously determines whether or not the recording timing has arrived, and when having determined that the recording timing has arrived, the recording unit 123 performs a recording process. The recording timing may be a timing at which an instruction from the battery monitoring device 4 or a request has been issued. In this case, a request may be issued from another on-vehicle control device (not shown) via a communication medium. The recording process is continuously performed by the battery management device 12 in each of: a vehicle V having mounted thereon a brand-new secondary battery 10; and a vehicle V having mounted thereon a secondary battery 10 that is a reuse article.

In this manner, the battery characteristic is recorded, by the recording unit 123 so as to be distinguishable for each unit cell (battery module 11 or battery cell 11a), and in association with the time information. The battery characteristic recorded by the recording unit 123 can be read out in an ex post facto manner. For example, a reading device of a diagnosis terminal or the like is used, and the reading device is connected so as to be communicable with the communication unit 45 of the battery monitoring device 4 via an on-vehicle gateway device (not shown). This reading device can read out the battery characteristic recorded in the recording unit 123, in association with the unit cell identification information (MID/CID) and the management device identification information (BMU-ID). Alternatively, with respect to a battery module device 1 individually taken out, an operator may separately use a terminal that corresponds to the input/output unit 12d, and this terminal may read out the battery characteristic recorded by the recording unit 123, in association with the unit cell identification information (MID/CID) and the management device identification information (BMU-ID).

In this manner, in Embodiment 1, due to the battery information processing system that includes: the state-of-charge calculation unit 129, the parameter calculation unit 130, the full charge capacity calculation unit 131, and the state-of-health calculation unit 132, which calculate the battery characteristics; and the recording unit 123, the battery characteristics that indicate battery characteristics in time series are recorded at each recording timing so as to be readable in an ex post facto manner. In the secondary battery reuse system 100, battery characteristics for each unit cell identification information (MID/CID) and management device identification information (BMU-ID) read out at the time of checkup of the vehicle V can be collected. This allows quick management as to which battery module 11 or battery cell 11a corresponding to which identification information should be combined. Without newly performing measurement at the time of disassembly of the secondary battery 10, it is possible to detect the state of each battery module 11 or battery cell 11a. For example, on the basis of the state detected based on the battery characteristics recorded by the recording unit 123, the module control unit 12a of the battery management device 12 may detect whether or not the replacement time has arrived, and when the replacement time has arrived, a notification of the arrival of the replacement time may be issued via the battery monitoring device 4. On the basis of the history of the battery characteristics during use, the replacement time can be more accurately detected.

(Embodiment 2)

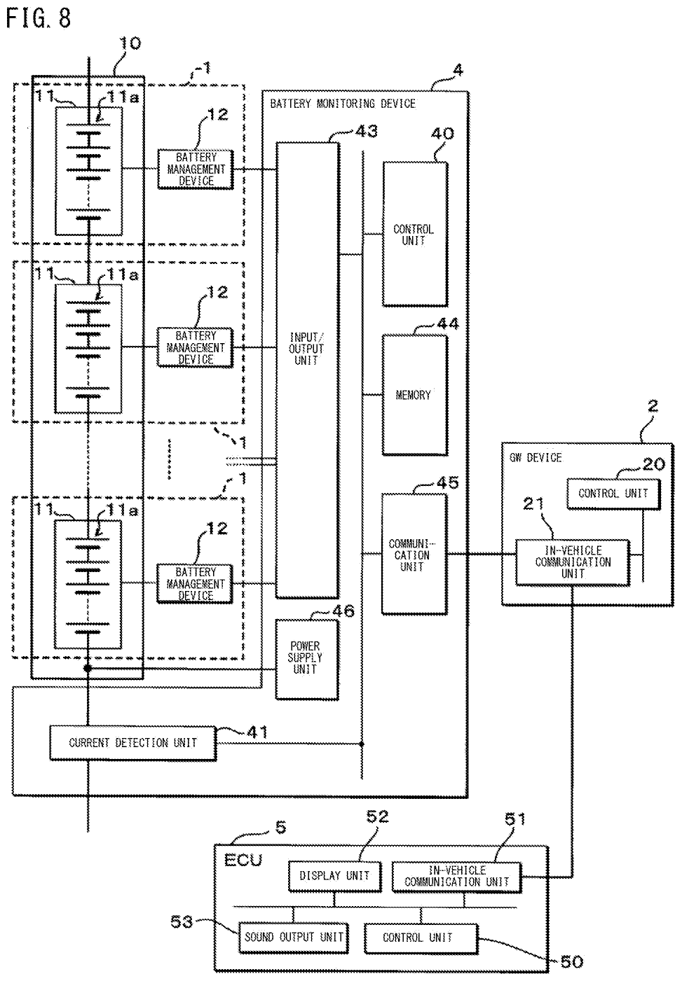

In Embodiment 2, recording of the battery characteristics are performed not by each battery management device 12 but by the battery monitoring device 4 to which all of the battery management devices 12 are connected. That is, in Embodiment 2, the battery information processing system included in the secondary battery reuse system 100 includes: a plurality of battery management devices 12 which each calculate battery characteristics for each of a plurality of unit cells; and a recording device (a control unit 40 and a memory 44 in FIG. 8) which records the calculated battery characteristics. FIG. 8 is a block diagram showing a part of a configuration of an on-vehicle communication system in Embodiment 2. The on-vehicle communication system shown in FIG. 8 is a system in the vehicle V included in the secondary battery reuse system 100. Components that are the same as those in Embodiment 1 are denoted by the same reference signs, and detailed descriptions thereof are omitted.

In Embodiment 2, the vehicle V has mounted thereto an on-vehicle communication system that includes: a battery monitoring device 4 connected to a secondary battery 10; a GW (Gate Way) device 2 connected to an in-vehicle LAN; and an ECU 5.

The GW device 2 includes a control unit 20 and an in-vehicle communication unit 21. The control unit 20 uses one or a plurality of processors and memories, to execute processes that control components. The GW device 2 is a communication device that relays information between different communication mediums included in the in-vehicle LAN.

The in-vehicle communication unit 21 realizes transmission/reception of information between the battery monitoring device 4 and the ECU 5 through in-vehicle communication. In Embodiment 1, the in-vehicle communication unit 21 performs communication through CAN communication, but may perform communication through wired communication or wireless communication according to another protocol.

The ECU 5 is an on-vehicle device that includes a control unit 50, an in-vehicle communication unit 51, a display unit 52, and a sound output unit 53, and that exhibits a function of outputting a message to an occupant. Only one of the display unit 52 and the sound output unit 53 may be provided. The control unit 50 controls the display unit 52 and the sound output unit 53 by using a microcomputer.

The in-vehicle communication unit 51 is connected to the in-vehicle LAN and realizes transmission/reception of information to/from another on-vehicle device.

The display unit 52 is an indicator lamp provided in a panel of instruments including a speed indicator on an instrument panel. An LED (Light Emitting Diode) may be used for the display unit 52. The display unit 52 may be a head up display. The display unit 52 may have built therein a touch panel to be used in a navigation system or the like and may use a display panel such as an LCD (Liquid Crystal Display) or an organic EL (Electro Luminescence). On the basis of control by the control unit 50, the display unit 52 displays images or characters.

The sound output unit 53 is a speaker, and emits a sound or a sound effect on the basis of control by the control unit 50.

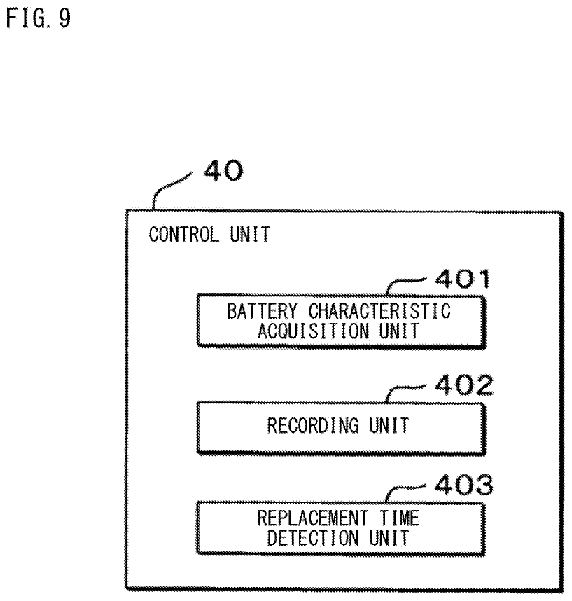

FIG. 9 is a function block diagram of the control unit 40 of the battery monitoring device 4 according to Embodiment 2. In Embodiment 2, the control unit 40 of the battery monitoring device 4 functions as a battery characteristic acquisition unit 401, a recording unit 402 which records battery characteristics into the memory 44, and a replacement time detection unit 403. In Embodiment 2, the module control unit 12a of the battery management device 12 may temporarily store battery characteristics sequentially calculated, but may not necessarily function as a recording unit 123 that sequentially records battery characteristics to a memory 12e, which is a nonvolatile storage medium.

The battery characteristic acquisition unit 401 acquires, through an input/output unit 43, a battery characteristic transmitted from the battery management device 12 of each battery module device 1, together with time information. Accordingly, the battery monitoring device 4 functions as a battery characteristic reading device. The recording unit 402 performs a process of recording, into the memory 44 at predetermined timings, the battery characteristic acquired via the input/output unit 43.

The replacement time detection unit 403 refers to, at predetermined timings, information recorded in the memory 44, and executes a process related to detection of abnormality in the secondary battery 10 and promotion of provision of the secondary battery 10 for reuse.

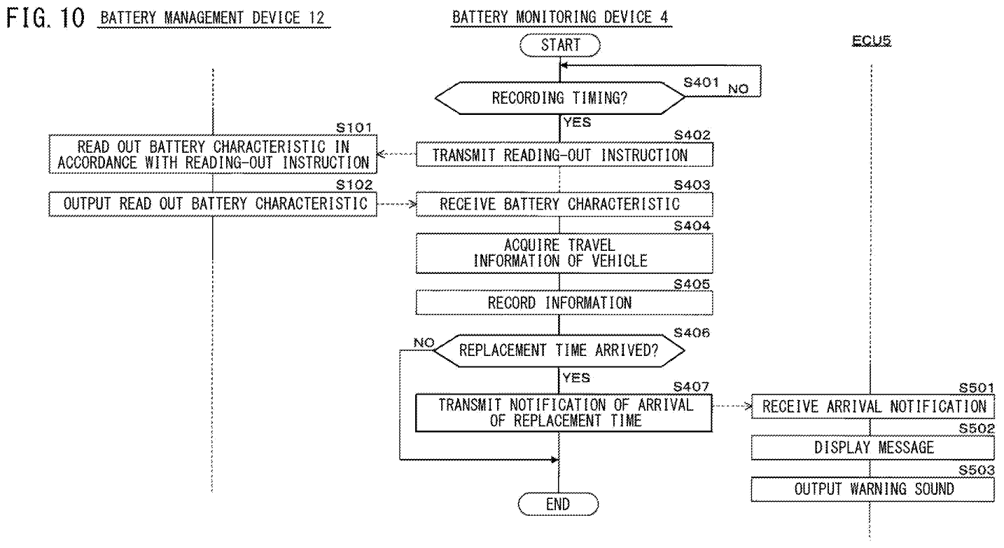

FIG. 10 is a flowchart showing an example of a procedure of a process performed in an on-vehicle communication system. In Embodiment 2, the control unit 40 of the battery monitoring device 4 determines whether or not the time is the recording timing (step S401). The recording timing is, for example, a timing that comes every constant period, such as once in one month. On the basis of time information obtained by a built-in timer, the control unit 40 determines that the time is the recording timing when the constant period has elapsed and the starting switch has entered an ON state from an OFF state.

When having determined that the time is not the recording timing (S401: NO), the control unit 40 returns the process to step S401. When having determined that the time is the recording timing (S401: YES), the control unit 40 sequentially issues a reading-out instruction, to the battery management device 12 of each battery module device 1 (step S402).

In each battery management device 12, in accordance with the instruction from the battery monitoring device 4, the control unit 121 reads out a battery characteristic having been sequentially (e.g., 10 milliseconds) calculated and having been temporarily stored (step S101). The control unit 121 outputs, from the input/output unit 12d to the battery monitoring device 4, the read out battery characteristic in association with the unit cell identification information (CID/BID) and the management device identification information (BMU-ID) stored in the recording unit 123 (step S102). In step S102, the control unit 121 also outputs information of the time at which the outputted battery characteristic has been calculated.

The control unit 40 receives, by means of the communication unit 45, the battery characteristic transmitted from the battery management device 12 in accordance with the reading-out instruction (step S403). The control unit 40 acquires, by means of the communication unit 45, travel information (travel distance, average speed, fuel consumption, etc.) of the vehicle V from other devices via the in-vehicle LAN (step S404).

The control unit 40 records, into the memory 44, the received battery characteristic, in association with the unit cell identification information (CID/BID) and the management device identification information (BMU-ID), and the travel information acquired in step S404 (step S405). In step S405, the control unit 40 also records corresponding time information having been received.

On the basis of the battery characteristics recorded in time series in the memory 44 and with reference to the travel information, the control unit 40 determines whether or not the replacement time of the secondary battery 10 has already arrived or will arrive in one year from now (step S406).

In step S406, the control unit 40 may determine whether or not it is predicted that the replacement time will arrive in one year, and when having determined that the replacement time will arrive in one year, the control unit 40 may determine that the replacement time has arrived. In step S406, in particular, when the state of health is at a predetermined proportion, such as 70%, i.e., when the full charge capacity is not higher than 70% when compared with that in the state of a new article, the control unit 40 determines that the replacement time has arrived. The control unit 40 may determine depending on whether or not the output voltage at the time of full charge is not greater than a predetermined proportion when compared with that in the state of a new article. When the fuel consumption included in the travel information has been deteriorated, the control unit 40 may determine that the replacement time has arrived.

When having been determined, in step S406, that the replacement time has not arrived (S406: NO), the control unit 40 ends the process. In this case, the control unit 40 waits from step S401 again, until the recording timing comes.

When having determined in step S406 that the replacement time will arrive or has arrived (S406: YES), the control unit 40 transmits a notification of arrival of the replacement time of the secondary battery 10, from the communication unit 45 toward the ECU 5 (step S407). Then, the control unit 40 of the battery monitoring device 4 ends the process performed at one recording timing. In step S407, preferably, the control unit 40 transmits the battery characteristic based on which the determination in step S406 has been made. The control unit 40 may transmit the travel information therewith.

In this case, in the ECU 5, the in-vehicle communication unit 51 receives the arrival notification (step S501), the control unit 50 causes the display unit 52 to display a message indicating an announcement of the replacement time (step S502), and causes the sound output unit 53 to output a warning sound (step S503).

As described above, in the battery monitoring device 4, separately from the detection of abnormality in the secondary battery 10, the control unit 40 notifies arrival of the replacement time. Thus, it is possible to promote replacement of the battery module 11 or battery cell 11a before being deteriorated to an extent that the battery module 11 or battery cell cannot be used even for reuse. As shown in Embodiment 2, instead of each battery management device 12, the battery monitoring device 4 to which all of the battery management devices 12 are connected collects and records battery characteristics so as to be readable later. Therefore, in particular, with respect to arrival of the replacement time, comprehensive determination also in consideration of the travel information can be performed.

(Embodiment 3)

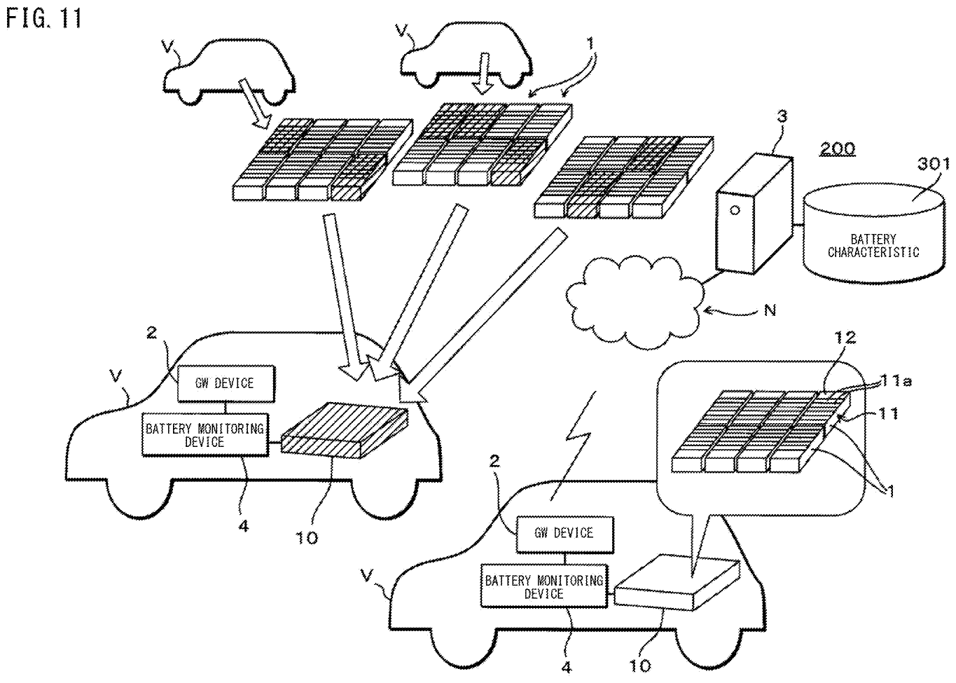

FIG. 11 shows an outline of a secondary battery reuse system 200 in Embodiment 3. In Embodiment 3, a server device 3 that is present outside the vehicles V collects battery characteristics of each unit cell of the secondary battery 10 of each vehicle V, and records the battery characteristics into a database 301. The secondary battery reuse system 200 of Embodiment 3 includes a battery information processing system that includes: a plurality of battery management devices 12 which each calculate battery characteristics for each of a plurality of unit cells; and a recording device (the server device 3 and the database 301) which records the calculated battery characteristics. The server device 3 and the database 301 are managed by an inspection agency for the secondary battery 10 or the vehicle V of which the secondary battery 10 is inspected, a third-party inspection service provider, or the like.

In Embodiment 3, the GW device 2 shown in Embodiment 2 has, in addition to the in-vehicle communication unit 21, a function of communicating with the outside of the vehicle, and can transmit/receive information via a network N to/from the server device 3. The network N includes a public communication network, and a carrier network that realizes wireless communication according to a predetermined mobile communication standard. The network N may include an optical beacon and a network of ITS (Intelligent Transport Systems). Except for a process in which the database 301 is used as the recording place, processes performed by the battery management device 12 and the battery monitoring device 4 in Embodiment 3 are similar to the processes shown in Embodiments 1 and 2. Among components of the secondary battery reuse system 200 in Embodiment 3, components that are the same as those in Embodiment 1 and Embodiment 2 are denoted by the same reference signs, and detailed descriptions thereof are omitted.

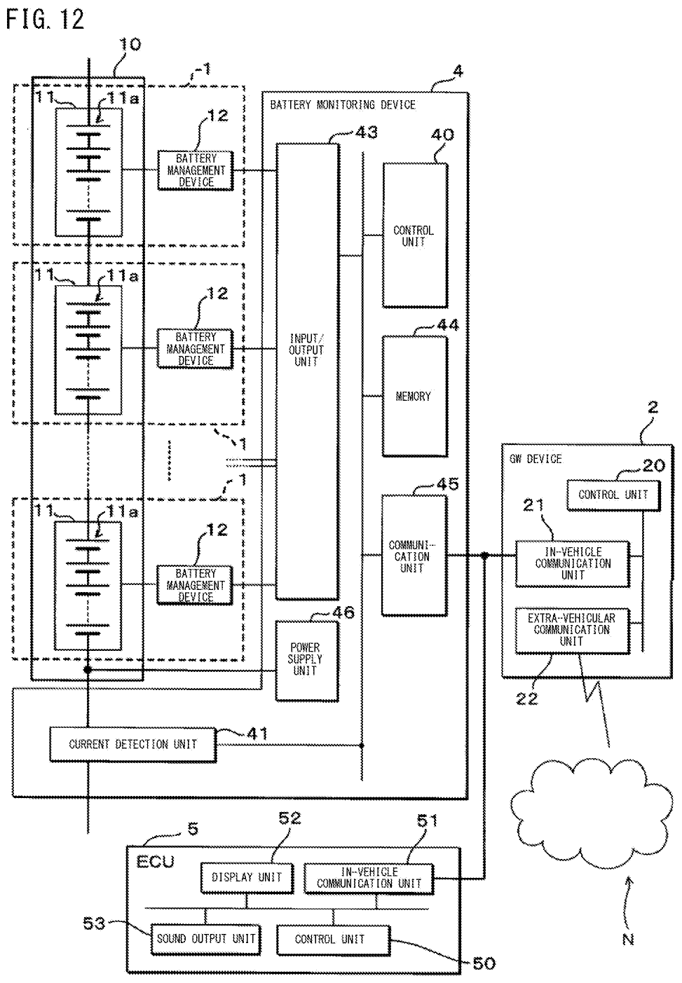

FIG. 12 is a block diagram showing a part of a configuration of an on-vehicle communication system in Embodiment 3. In Embodiment 3, the GW device 2 includes an extra-vehicular communication unit 22. The extra-vehicular communication unit 22 is a unit that transmits/receives information by means of a radio signal to/from a communication device (including a wireless communication device brought into the vehicle) other than on-vehicle devices. The extra-vehicular communication unit 22 can be communicably connected to the network N via a communication device thereof, and can transmit/receive information to/from the server device 3. The extra-vehicular communication unit 22 is a wireless communication unit that can perform Wi-Fi communication, or that can be communicably connected to an access point AP of a communication network provided by a communication provider. The extra-vehicular communication unit 22 may use Bluetooth (registered trademark). The extra-vehicular communication unit 22 may be a wireless communication module according to a predetermined mobile communication standard. The extra-vehicular communication unit 22 may transmit/receive information to/from the server device 3 via a communication device outside the vehicle and the network N, by using an optical beacon or an ITS wireless communication standard. The extra-vehicular communication unit 22 may be an interface such as a diagnosis port for abnormality diagnosis or log extraction, and the control unit 20 may transmit information through the extra-vehicular communication unit 22 to a predetermined diagnosis terminal. In this case, the information received by the diagnosis terminal is transmitted to the server device 3 through a terminal device that is used in an inspection agency, via the network N.

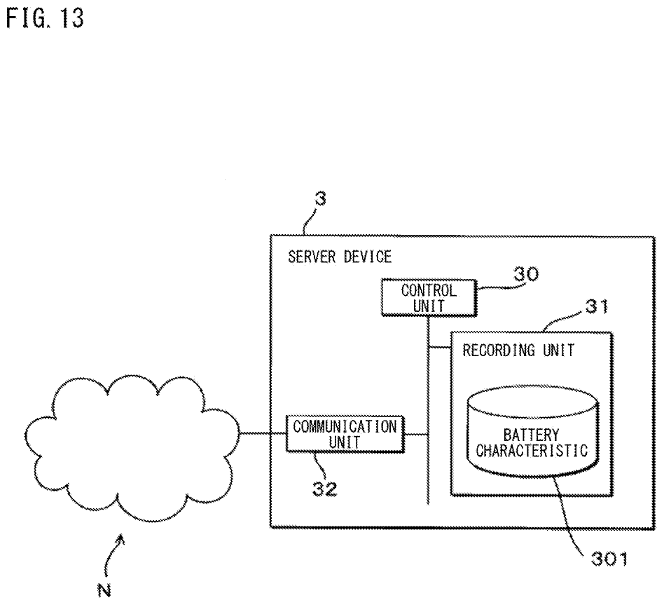

FIG. 13 is a block diagram of the server device 3. The server device 3 uses a server computer, and includes a control unit 30, a recording unit 31, and a communication unit 32. In the present embodiment, the server device 3 is described as one server computer, but a configuration may be adopted in which a plurality of server computers perform processes in a distributed manner.

The control unit 30 is a processor using a CPU or a GPU (Graphics Processing Unit), uses memories such as built-in ROM and RAM, and executes processes by controlling components. The control unit 30 executes information processing based on a computer program stored in the recording unit 31.

As for the recording unit 31, a nonvolatile storage medium such as a hard disk, an SSD (Solid State Drive), or a flash memory is used, for example. The recording unit 31 records, into the database 301, for each unit cell (battery module 11 or battery cell 11a), information that indicates battery characteristics in association with the unit cell identification information (MID/CID) that identifies the unit cell. The database 301 may be a storage device outside the server device 3.

The communication unit 32 is a communication device that realizes communication connection and transmission/reception of data via the network N. Specifically, the communication unit 32 is a network card corresponding to the network N.

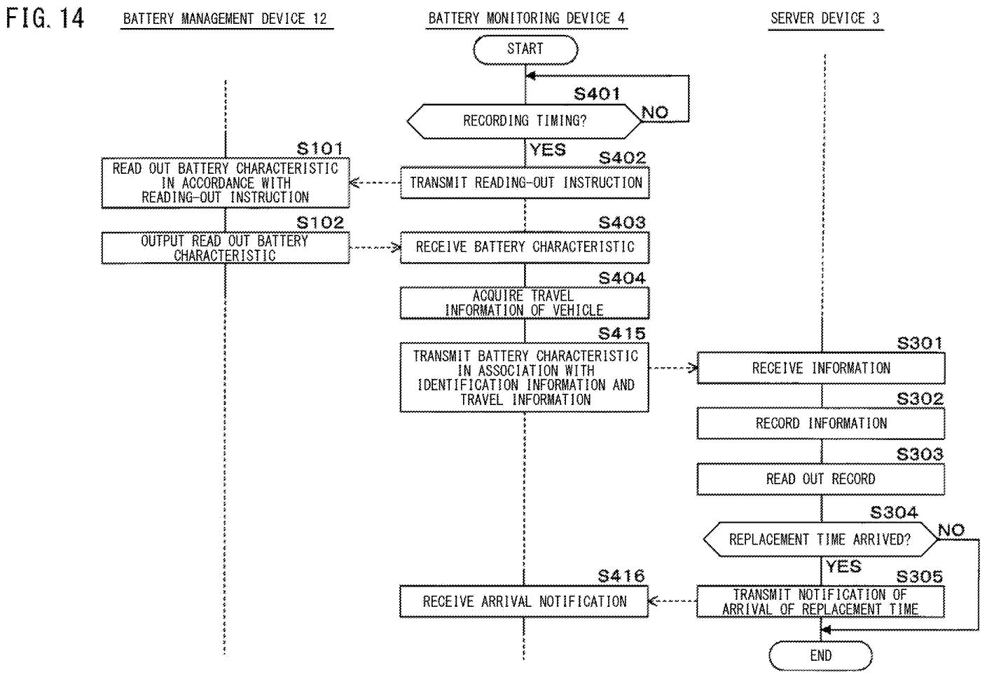

FIG. 14 is a flowchart showing an example of a procedure of a process performed by each device in the secondary battery reuse system 200 of Embodiment 3. In the process procedure shown in the flowchart in FIG. 14, steps that are the same as those performed by the battery management device 12 and the battery monitoring device 4 in the flowchart in FIG. 10 are denoted by the same step numbers, and detailed descriptions thereof are omitted.

The control unit 40 of the battery monitoring device 4 receives a battery characteristic from the battery management device 12 (S403), and acquires travel information of the vehicle V via the in-vehicle LAN (S404). The control unit 40 transmits, to the server device 3, the battery characteristic received in step S403, in association with identification information such as the unit cell identification information (CID/BID) and the management device identification information (BMU-ID) and the travel information acquired in step S404 (step S415). In step S415, the control unit 40 also transmits time information that corresponds to the battery characteristic and that has been received from the battery management device 12, and vehicle body identification information of the vehicle V.

In the server device 3, the communication unit 32 receives the battery characteristic (step S301). The control unit 30 records, into the database 301, the battery characteristic received by the communication unit 32, in association with the unit cell identification information (CID/BID) and the management device identification information (BMU-ID) (step S302). In step S302, the control unit 30 also records, into the database 301, time information received corresponding thereto.

The control unit 30 reads out the battery characteristic recorded for each unit cell in the database 301 (step S303). Accordingly, the server device 3 functions as a battery characteristic reading device. On the basis of the read out battery characteristic, the control unit 30 determines, for each vehicle V, i.e., for each secondary battery 10, whether or not the replacement time will arrive or has arrived (step S304). In step S304, the control unit 30 collects the battery characteristic for each unit cell with which the same vehicle body identification information is associated, and may perform the determination on the basis of the state of health, the full charge capacity, and the travel information, as described in step S405 of the flowchart in FIG. 10. In a case where whether or not the replacement time will arrive can be determined in the server device 3 having abundant hardware resources, the control unit 30 may perform statistic processing (regression analysis, T-method, etc.) or deep learning in advance on the basis of records of battery characteristics in time series of each unit, to perform the determination. In these determination methods, the control unit 30 may use a learning model created in advance so as to output a predicted life of the unit cell when the battery characteristics are used as inputs, and may perform the determination with reference to the outputted life.

When having determined that the replacement time has not arrived in step S304 (S304: NO), the control unit 30 ends the process.

When having determined that the replacement time will arrive or has arrived in step S304 (S304: YES), the control unit 30 transmits a notification of arrival of the replacement time to the vehicle V (step S305), and ends the process.

In step S304, the control unit 30 preferably makes a notification to a manufacturer of another vehicle V, a dealer, a checkup service provider, and a manufacturer of the secondary battery 10, together with the vehicle body identification information, or the unit cell identification information (CID/BID) and the management device identification information (BMU-ID). Accordingly, not only the user of the vehicle V but also the dealer or the manufacturer can recognize that the replacement time of the secondary battery 10 of the vehicle V has arrived. Since the dealer, the manufacturer, or the like can recognize as above, it is possible to provide the unit cell included in the secondary battery 10 being used, for production of a reuse article. At the same time, it is possible to realize a service of presenting, to the user, benefits and the like of replacing the secondary battery 10 with a new secondary battery 10 or with a reproduced secondary battery 10 which is a reuse article, and it is possible to promote use of the secondary battery reuse system 200.

In the vehicle V, for example, the battery monitoring device 4 or the ECU 5 receives the arrival notification from the server device 3 (step S416), and notifies the user of the arrival of the replacement time, by using the on-vehicle display unit 52 or the like.

In Embodiment 3, the server device 3 outside the vehicle V records the battery characteristic into the database 301 for each unit cell. It is preferable that devices mounted to the vehicle V are as simple as possible, but when the battery characteristics are recorded into the server device 3 having abundant resources such that the battery characteristics can be read out therefrom, highly accurate determination can be expected to be performed. In addition, when the determination is performed in the server device 3, it is possible not only to notify the user of the arrival of the replacement time, but also to easily make the notification to battery manufacturers and the manufacturer of the vehicle V. In addition, at the time of checkup at the manufacturer of the vehicle V, a service of urging provision of the unit cell to the secondary battery reuse system 200 can be easily realized. Based on the provision of the unit cell to the secondary battery reuse system 200, a benefit such as discount of a new secondary battery 10 can be presented from the manufacturer of the vehicle V.

(Embodiment 4)

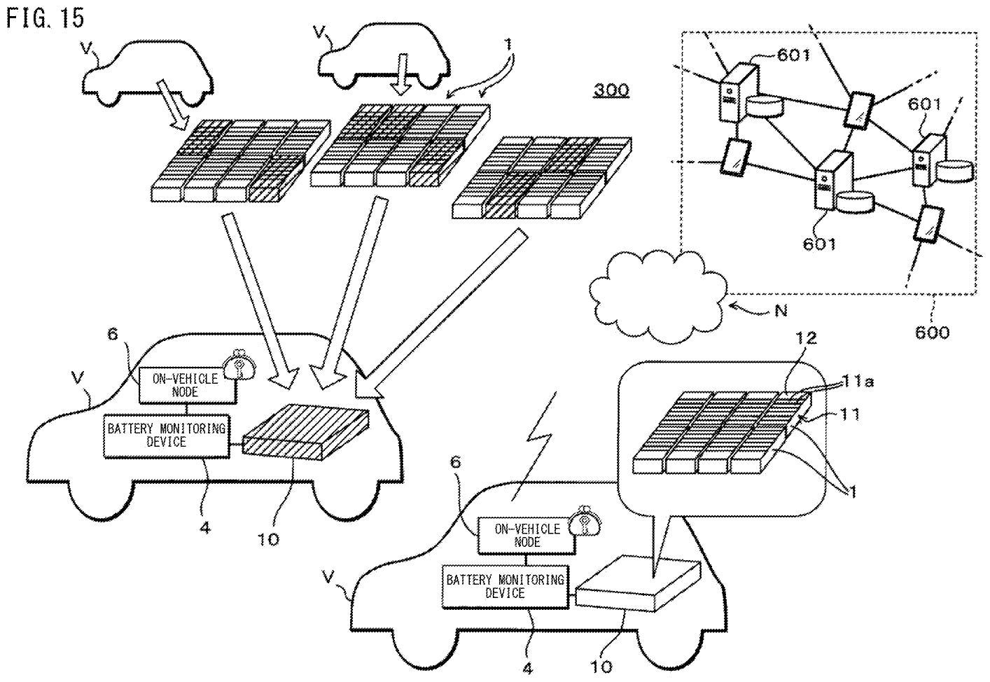

FIG. 15 shows an outline of a secondary battery reuse system 300 in Embodiment 4. In Embodiment 4, recording of battery characteristics is executed in a distributed-type DB network system 600 that is a so-called block chain. The distributed-type DB network system 600 includes storage mediums and a plurality of nodes 601 that perform predetermined arithmetic operations. The secondary battery reuse system 300 of Embodiment 4 includes a battery information processing system that includes: a plurality of battery management devices 12 which each calculate battery characteristics for each of a plurality of unit cells; and a recording device (distributed-type DB network system) which records the calculated battery characteristics.

In Embodiment 4, the vehicle V has installed therein an on-vehicle node 6 which is a communication device having a secret key itself or a wallet address based on the secret key. The on-vehicle node 6 can acquire battery characteristics of each unit cell of the secondary battery 10 by being connected to the battery monitoring device 4. The secret key itself may be assigned for each unit cell, and the on-vehicle node 6 may store and use the wallet address based on the secret key of each unit cell included in the secondary battery 10 of the vehicle V having the on-vehicle node 6 installed therein. Conversely, a plurality of wallet addresses that can be created on the basis of a secret key corresponding to the on-vehicle node 6 may be assigned to a plurality of respective unit cells included in the secondary battery 10 and may be used. The wallet address of each unit cell may be used as the unit cell identification information.

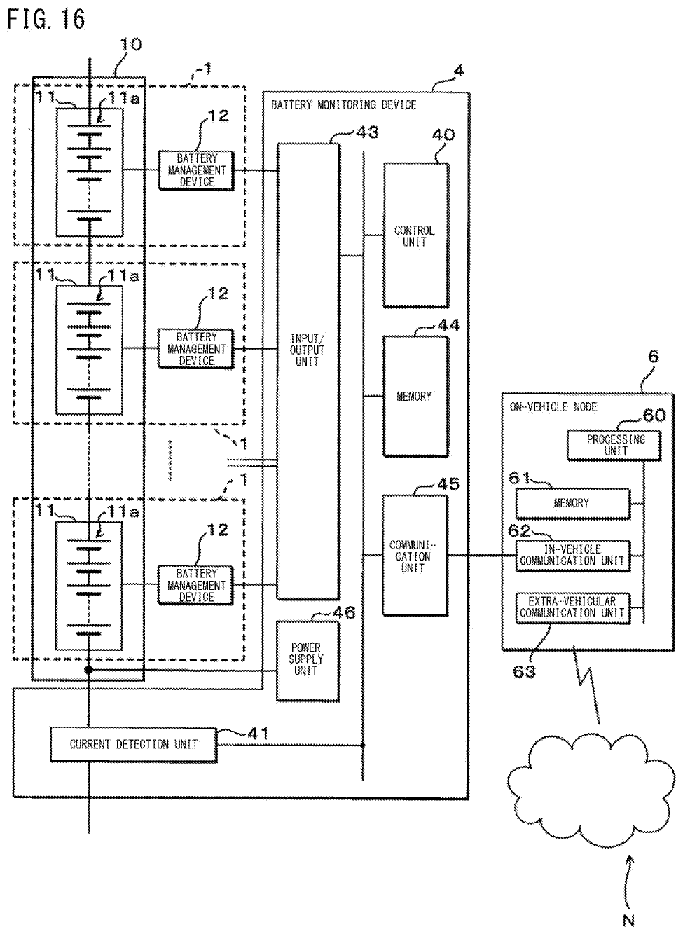

FIG. 16 is a block diagram showing a part of a configuration of an on-vehicle communication system in Embodiment 4. In Embodiment 4, as described above, the vehicle V has installed therein an on-vehicle node 6 communicably connected to the battery monitoring device 4. The on-vehicle node 6 includes a processing unit 60, a memory 61, an in-vehicle communication unit 62, and an extra-vehicular communication unit 63. As the processing unit 60, a processor such as a CPU or a GPU, a memory, and the like are used. The processing unit 60 may be implemented as one piece of hardware (SoC: System On a Chip) obtained by integrating a processor, a memory, and further, the memory 61, the in-vehicle communication unit 62, and the extra-vehicular communication unit 63. The secret key is preferably stored in a non-rewritable manner in hardware (as a wallet chip), i.e., in a memory of the processing unit 60.

A flash memory is used as the memory 61, and information such as programs and data referred to by the processing unit 60 are stored in the memory 61. The above-described secret key may be stored in the memory 61. The memory 61 has stored therein a public key and a wallet address based on the secret key.

The in-vehicle communication unit 62 realizes transmission/reception of information to/from the battery monitoring device 4. In Embodiment 4, the on-vehicle node 6 may not necessarily communicate with on-vehicle devices other than the battery monitoring device 4.

The extra-vehicular communication unit 63 is a unit that transmits/receives information by means of a radio signal to/from a communication device (including a wireless communication device brought into the vehicle) other than on-vehicle devices. The extra-vehicular communication unit 63 can be communicably connected to the network N via a communication device thereof, and can transmit information toward one of a plurality of nodes 601 included in the distributed-type DB network system 600. The extra-vehicular communication unit 63 is, for example, a wireless communication module according to a predetermined mobile communication standard. The extra-vehicular communication unit 63 is a wireless communication unit that can perform Wi-Fi communication or that can be communicably connected to an access point AP of a communication network provided by a communication provider. The extra-vehicular communication unit 63 may use Bluetooth (registered trademark).

The on-vehicle node 6 having this configuration outputs (transmits) a transaction of causing the battery characteristic to be recorded into the distributed-type DB network system 600 including the on-vehicle node 6 and the nodes 601 outside the vehicle V. In the transaction, a signature according to the wallet address (unit cell identification information) stored in the on-vehicle node 6 is used. As the transaction, for example, a transaction of transmitting a battery characteristic from the wallet address of the on-vehicle node 6 to the wallet address of a specific node (registration node) can be used. The battery characteristic may be converted to a hash value and then transmitted.

A transaction of recording a battery characteristic based on the wallet address of each on-vehicle node 6 is subjected to a process of verifying the signature in the transaction by using the public key of the on-vehicle node 6, and then is recorded into the distributed-type DB network system 600, such that the transaction can be viewed through communication from any node 601 and devices outside the distributed-type DB network system 600.

Use of battery characteristics recorded in the distributed-type DB network system 600 in this manner is described. The battery characteristics recorded in the distributed-type DB network system 600 can be confirmed as highly accurate battery characteristics of each unit cell, as shown in Embodiment 1 to Embodiment 3. Therefore, the operator can grasp the state of health and the like of each unit cell, without performing inspection at the stage of disassembly of the secondary battery 10.

Since the on-vehicle node 6 that can output a transaction to the distributed-type DB network system 600, which is a so-called block chain, is used, information related to the unit cell can be distributed in the distributed-type DB network system 600.

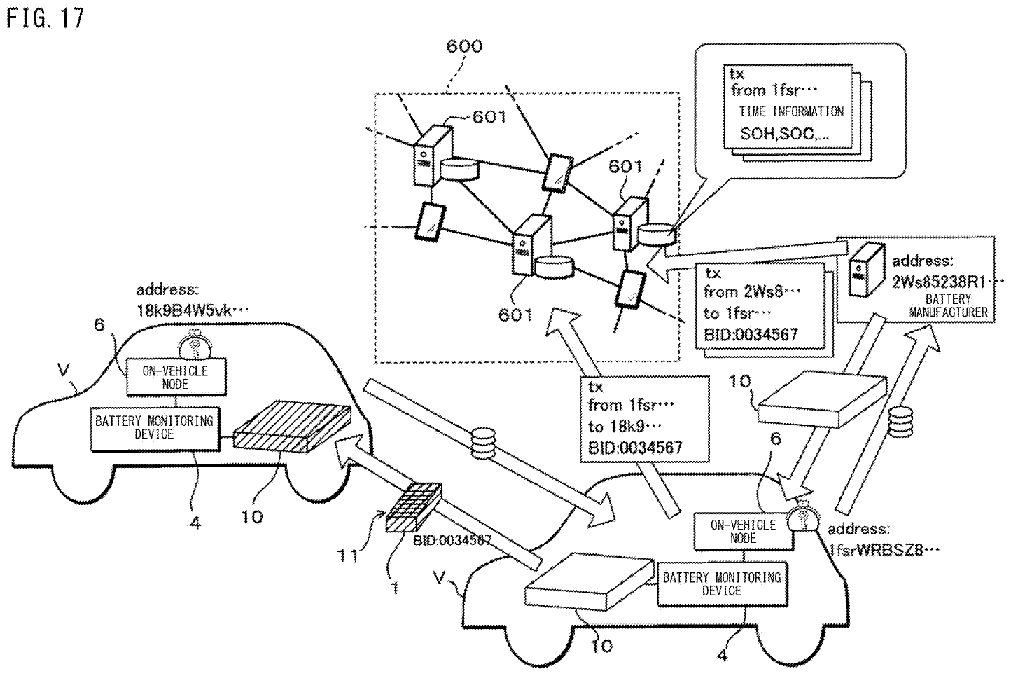

FIG. 17 shows an outline of distribution of information in the distributed-type DB network system 600. First, the on-vehicle node 6 outputs a transaction of recording, for each unit cell, a highly accurate battery characteristic obtained by the battery management device 12. It is also possible to record distribution of unit cells as resources (transfer from a secondary battery 10 which is one battery pack to another secondary battery 10). The distributed-type DB network system 600 may be provided with a specific node 601 that is configured to execute a smart contract that processes a transaction of registration of transfer. First, at the time of mounting a secondary battery 10 to the vehicle V, with respect to each unit cell included in the secondary battery 10, a transaction of transferring the unit cell identification information (CID/BID) is outputted from a specific node managed by the manufacturer of the secondary battery 10, the manufacturer of the vehicle V, or the like, to the on-vehicle node 6 installed in the vehicle V. Accordingly, the wallet address of the on-vehicle node 6 which is the transfer destination of the unit cell identification information (CID/BID) becomes clear on the distributed-type DB network system 600. At the time of recombination, a transaction of transfer from the on-vehicle node 6 of the original vehicle V to a device (a vehicle V, another vehicle such as a cart, a stationary storage battery, etc.) to which the secondary battery 10 after the recombination is to be mounted, may be used. The transaction at the time of recombination may be a transaction in which the unit cell identification information (CID/BID) is transferred from the on-vehicle node 6 of the original vehicle V to a specific node 601 managed by a battery provider that performs the recombination.

The transfer transaction may be set such that recording into the distributed-type DB network system 600 is realized only through multi signature in which secret keys or the like respectively corresponding to the transfer source node and the transfer destination node (device) are used. At the time of transfer, a transaction of payment of compensation of virtual currency as a consideration of the transfer between on-vehicle nodes 6 may be recorded. This allows payment to the vehicle V of remuneration in terms of digital assets such as virtual currency, for the provision of the unit cell to the secondary battery reuse system 300. The secret key of the on-vehicle node 6 of the vehicle V is managed by the user who is the owner of the vehicle V, whereby payment of virtual currency to the owner who provides the secondary battery 10 can be managed.

The transfer transaction may be outputted upon reception of a transfer instruction at a node such as an on-vehicle node 6 via a node operable by, for example, an owner (initially, the manufacturer of the secondary battery 10 or the manufacturer of the vehicle V) who knows the secret key of the secondary battery 10.

The function of the on-vehicle node 6 shown in Embodiment 4 may be incorporated in the battery monitoring device 4.

As described above, when battery characteristics, identification information, and the like related the unit cell included in the secondary battery 10 are recorded into the distributed-type DB network system 600, distribution of the unit cell as a resource can be activated, traceability can be improved, and the value of the unit cell can be assured.

In each of Embodiments 1 to 3, an example in which the secondary battery 10 is firstly used to supply drive power of the vehicle V has been described. However, in the secondary battery reuse system 100 (200 or 300), the battery characteristics of a secondary battery during use not only in the vehicle V but also in a cart, etc., and a stationary power storage device, etc., may also be recorded in a collectable manner. Other than this, the secondary battery reuse system 100 (200 or 300) of the present disclosure can be applied to any system in which a secondary battery obtained by combining a plurality of unit cells (battery cells 11a or battery modules 11) is used.

### REFERENCE SIGNS LIST

100, 200, 300 secondary battery reuse system
1 battery module device
10 secondary battery
1a holding member
11 battery module (unit cell)
11a battery cell (unit cell)
11b electrode terminal
12 battery management device
12a module control unit
12b voltage detection circuit
12c temperature detection circuit
120c temperature sensor
12d input/output unit
12e memory
12f power supply circuit
12g support plate
12h circuit board
12i connection terminal
12j conductive wire
12k circuit board
12m output terminal
12l control unit
122 timer
123 recording unit
124 input/output processing unit
125 voltage acquisition unit
126 current acquisition unit
127 temperature acquisition unit
128 current integration unit
129 state-of-charge calculation unit
130 parameter calculation unit
131 full charge capacity calculation unit
132 state-of-health calculation unit
2 GW device
20 control unit
21 in-vehicle communication unit
22 extra-vehicular communication unit
3 server device
30 control unit
31 recording unit
32 communication unit
301 database
4 battery monitoring device
40 control unit
41 current detection unit
43 input/output unit
44 memory
45 communication unit
46 power supply unit
401 battery characteristic acquisition unit
402 recording unit
403 replacement time detection unit
5 ECU
50 control unit
51 in-vehicle communication unit
52 display unit
53 sound output unit
6 on-vehicle node
60 processing unit
61 memory
62 in-vehicle communication unit
63 extra-vehicular communication unit
600 distributed-type DB network system
601 node
N network
V vehicle

1. A battery management device comprising:
a calculation unit configured to calculate, for each of a plurality of unit cells included in a secondary battery, a battery characteristic in the secondary battery; and
a recording unit configured to record the battery characteristic of each unit cell calculated by the calculation unit, in association with unit cell identification information for identifying the unit cell, and time information indicating a time at which the battery characteristic has been calculated.

2. The battery management device according to claim 1, comprising
a detection unit configured to detect arrival of a replacement time of the secondary battery on the basis of the battery characteristic recorded in the recording unit.

3. A battery information processing system configured to process information indicating a characteristic of a secondary battery including a plurality of unit cells, the battery information processing system comprising:
a plurality of battery management devices connected to the plurality of unit cells and each configured to calculate a battery characteristic for each unit cell; and
a recording device configured to record, separately for each unit cell, the battery characteristic calculated for each unit cell, in association with unit cell identification information for identifying the unit cell and time information indicating a time at which the battery characteristic has been calculated.

4. The battery information processing system according to claim 3, wherein
the recording device is provided to a device different from an apparatus that operates by receiving supply of power from the secondary battery,
the battery management device includes a transmission unit configured to transmit the calculated battery characteristic to the recording device, in association with the unit cell identification information and the time information, and
the recording device
includes a reception unit configured to receive the battery characteristic, and
records the received battery characteristic of each unit cell in association with the unit cell identification information and the time information.

5. The battery information processing system according to claim 3, wherein
the battery characteristic includes at least one of a full charge capacity, a state of charge, a state of health, and a battery equivalent circuit parameter of the unit cell.

6. The battery information processing system according to claim 3, further comprising
a reading device configured to read out the battery characteristic recorded in the recording device, wherein
the reading device includes a detection unit configured to detect arrival of a replacement time on the basis of the read out battery characteristic.

7. The battery information processing system according to claim 3, wherein
the recording device is a distributed-type database network system, the distributed-type database network system being formed by a plurality of recording mediums and processing nodes each configured to perform arithmetic operation of verifying and approving record information for recording attribution of information on the basis of an electronic signature obtained from secret key information corresponding to a transfer source, the distributed-type database network system being configured to record information such that results of the arithmetic operations are distributed in a plurality of recording mediums, and
the battery information processing system includes a node, the node being connected to the battery management device and configured to transmit, to the distributed-type database network system, a transaction of recording the battery characteristic calculated by the battery management device into the distributed-type database network system.

8. The battery information processing system according to claim 7, wherein
the node creates the transaction on the basis of a signature using address information obtained on the basis of secret key information and different for each unit cell.

9. The battery information processing system according to claim 7, wherein
the distributed-type database network system includes a node configured to process a transaction of registering a transfer by using unit cell identification information, for each unit cell.

10. A battery information processing method for processing information indicating a characteristic of a secondary battery including a plurality of unit cells, the battery information processing method comprising:
calculating, performed by a device connected to the plurality of unit cells, a battery characteristic for each unit cell;
recording, separately for each unit cell, the battery characteristic calculated for each unit cell, in association with time information indicating a time at which the battery characteristic has been calculated; and
identifying a state of each unit cell, on the basis of a history of the battery characteristic recorded separately for each unit cell.
